(19) United States
(12) Patent Application Publication
(10) Pub. No.: US 2024/0204246 A1
(43) Pub. Date: Jun. 20, 2024

(54) SOLID ELECTROLYTE COMPOSITION EXCELLENT IN STABILITY AGAINST WATER AND ION CONDUCTIVITY, AND METHOD FOR PREPARING THE SAME

(71) Applicants: INDUSTRY-ACADEMIC COOPERATION FOUNDATION OF SUNCHON NATIONAL UNIVERSITY, Suncheon-si (KR); INDUSTRY ACADEMY COOPERATION FOUNDATION OF SEJONG UNIVERSITY, Seoul (KR)

(72) Inventors: Kee Sun SOHN, Seoul (KR); Myoung Ho PYO, Suncheon-si (KR); Woon Bae PARK, Suncheon-si (KR); Jung Yong SEO, Suncheon-si (KR)

(21) Appl. No.: 18/534,858

(22) Filed: Dec. 11, 2023

(30) Foreign Application Priority Data
Dec. 14, 2022 (KR) 10-2022-0174580

(51) Int. Cl. H01M 10/0562; H01M 10/054

(52) U.S. Cl. CPC H01M 10/0562; H01M 10/054; H01M 2300/0068

(57) ABSTRACT

The invention relates to a solid electrolyte composition and a method for producing the same. The solid electrolyte composition according to the invention is characterized by including a material represented by [Formula 1] below.

NaₐZn_{b}Ga_{c}S_{d} Formula 1
(wherein, 2.70≤a≤2.90, 0.70≤b≤0.90, and 1.10≤c≤1.30)

### BACKGROUND OF THE INVENTION

### 1. Field of the Invention

The present invention relates to a sulfide-based solid electrolyte composition, which has good stability against water and has ion conductivity sufficient to be applied to an all-solid-state battery, and a preparation method thereof.

### 2. Description of the Related Art

Oxide solid electrolytes represented by NASICON and β/β″-alumina have properties of easily diffusing Na⁺ ions, and thus, are applied to commercial energy storage systems in high-temperature environments (245° C. to 300° C.).

The room-temperature ionic conductivity (σion) of such an oxide solid electrolyte may reach a level close to the ionic conductivity of a liquid electrolyte. However, such high room-temperature ionic conductivity may be obtained when a densified pellet is sintered at a high temperature (1200° C. to 1600° C.) that reduces grain boundary resistance, which makes it difficult for the oxide solid electrolyte to be applied to commercial secondary batteries for everyday use.

In contrast, a sulfide-based solid-phase electrolyte does not require a high-temperature sintering process, and a low modulus of elasticity of a soft sulfide enables the manufacturing of a battery by an industrially applicable method (e.g., cold pressing). However, a sulfide-based solid-phase electrolyte previously developed has room for improvement in terms of various properties.

### PRIOR ART DOCUMENT

### Patent Document

(Patent Document 0001) Chinese Patent Laid-Open Publication No. 113363570

### SUMMARY OF THE INVENTION

The purpose of the invention is to provide a solid electrolyte composition excellent in stability against water and ion conductivity, and a method for preparing the composition.

According to an aspect of the invention, there is provided a solid electrolyte composition including a material represented by [Formula 1] below.

NaₐZn_{b}Ga_{c}S_{d} Formula 1
(Here, 2.70≤a≤2.90, 0.70≤b≤0.90, and 1.10≤c≤1.30)

According to another aspect of the invention, there is provided a method for preparing a solid electrolyte composition including a material represented by [Formula 1] below, wherein the method includes
(a) mixing raw materials,
(b) heating the mixed materials to a predetermined temperature and maintaining the same for a predetermined period of time, and
(c) cooling the heated materials.

NaₐZn_{b}Ga_{c}S_{d} [Formula 1]
(Here, 2.70≤a≤2.90, 0.70≤b≤0.90, and 1.10≤c≤1.30)

### Advantageous Effects

A solid electrolyte composition according to the invention has good ion conductivity to be applied to an all-solid-state battery.

In addition, the solid electrolyte composition according to the invention is not substantially decomposed or forms a hydrate in a humid atmosphere or in water, thereby facilitating water-phase synthesis or water-phase processing.

In addition, the solid electrolyte composition according to the invention does not undergo continuous decomposition at the interface in a Na alloying/dealloying reaction and has good cycle properties.

### BRIEF DESCRIPTION OF THE DRAWINGS

FIG. 1 is an XRD pattern of a material synthesized with a composition of Na₃₋ₓZn₁₋ₓGa₁₊ₓS₄ (x=0, 0.05, 0.10, 0.15, 0.20, 0.30, 0.40, and 0.50);

FIG. 2 is an EIS spectrum of Na₃₋ₓZn₁₋ₓGa₁₊ₓS₄ (x=0 to 0.50) under the AC voltage modulation of ±10 mV at room temperature, and 2 MHz to 0.1 Hz;

FIG. 3 is an Arrhenius plot of ion conductivity (Sᵢₒₙ) in Na₃₋ₓZn₁₋ₓGa_{1+X}S₄ (x=0 to 0.30) between −20° C. to +60° C.;

FIG. 4 shows the change in ion conductivity (Sᵢₒₙ) and activation energy (E_{A}) according to x at 30° C.;

FIG. 5 shows the results of measuring the change in concentration of H₂S gas released from the composition of Na_{2.8}Zn_{0.8}Ga_{1.2}S₄, Na₃PS₄, and Na₃SbS₄ during the exposure to wet N₂;

FIG. 6 is an XRD pattern of Na_{2.8}Zn_{0.8}Ga_{1.2}S₄ in an initial/wet state;

FIG. 7 is an XRD pattern of Na₃SbS₄ in an initial/wet state;

FIG. 8 shows the change in voltage during Na alloying/dealloying in a symmetric Na₂Sn|Na_{2.8}Zn_{0.8}Ga_{1.2}S₄|Na₂Sn cell; and

FIG. 9 is a voltage curve of Na₂Sn|Na_{2.8}Zn_{0.8}Ga_{1.2}S₄|TiS₂ during a constant current cycle at 0.03 mAcm⁻².

### DETAILED DESCRIPTION OF THE EXEMPLARY EMBODIMENTS

Hereinafter, embodiments of the present invention will be described in detail with reference to the accompanying drawings so that those skilled in the art to which the present application pertains may easily practice the embodiments. The present invention may, however, be embodied in many different forms and should not be construed as limited to the embodiments set forth herein.

In addition, in order to clearly describe the present invention, parts irrelevant to the description are omitted in the drawings, and like reference numerals designate like elements throughout the specification.

Throughout the present specification, when a part is referred to as “including” another component, it means the part may further include other components, rather than excluding other components, unless specifically stated otherwise.

The terms “about,” “substantially,” and the like used herein are used in a sense that is close to a numerical value presented with a manufacturing and material tolerance specific to a stated meaning, and is used to prevent an unscrupulous person from abusing a disclosure in which an exact or absolute value is stated in order to facilitate the understanding of the invention.

In addition, the term “a step ˜ing,” or “a step of ˜,” as used throughout the specification, does not mean “a step for ˜.”

Throughout the present specification, the description of “A and/or B” means “A or B, or A and B.”

A solid electrolyte composition according to the present invention is characterized by including a material represented by [Formula 1] below.

NaₐZn_{b}Ga_{c}S_{d} Formula 1
(Here, 2.70≤a≤2.90, 0.70≤b≤0.90, and 1.10≤c≤1.30)

When the contents of Na, Zn, and Ga described in [Formula 1] above are out of the above range, it is difficult to obtain ion conductivity sufficient to be applied to a solid electrolyte of an all-solid-state battery, so that it is preferable to maintain the above range.

The Na content (a) is more preferably 2.725 to 2.875, even more preferably 2.75 to 2.85, and most preferably 2.775 to 2.825.

The Zn content (b) is more preferably 0.725 to 0.875, even more preferably 0.75 to 0.85, and most preferably 0.775 to 0.825.

The Ga content (c) is more preferably 1.125 to 1.275, even more preferably 1.15 to 1.25, and most preferably 1.175 to 1.225.

In the solid electrolyte composition, the space group of the material represented by [Formula 1] above may be I4₁/acd.

In the solid electrolyte composition, the ion conductivity σion at room temperature (25° C.) of the material represented by [Formula 1] above may be 0.1 mScm⁻¹ or greater. In addition, the ion conductivity σᵢₒₙ at room temperature (25° C.) of the solid electrolyte composition may be 0.15 mScm⁻¹ or greater, 0.2 mScm⁻¹ or greater, 0.25 mScm⁻¹ or greater, or most preferably 0.3 mScm⁻¹ or greater.

In the solid electrolyte composition, the material represented by [Formula 1] above may be substantially inert to moisture or water.

In the solid electrolyte composition, the crystal structure of the material represented by [Formula 1] above may be a tetragonal phase.

A method for preparing a solid electrolyte composition according to the invention is to prepare the aforementioned solid electrolyte composition, and
is a method for preparing a solid electrolyte composition including a material represented by [Formula 1] below, wherein the method includes
(a) mixing raw materials,
(b) heating the mixed materials to a predetermined temperature and maintaining the same for a predetermined period of time, and
(c) cooling the heated materials.

NaₐZn_{b}Ga_{c}S_{d} Formula 1
(Here, 2.70≤a≤2.90, 0.70≤b≤0.90, and 1.10≤c≤1.30)

In the method for preparing a solid electrolyte composition, any of various known methods for mixing powder may be used as the mixing method.

In the method for preparing the solid electrolyte composition, it is preferable that the step (b) is performed at 700° C. to 800° C. for 12 hours to 48 hours.

When the heating temperature is lower than 700° C., the raw materials may remain in the raw material state even after a synthesis process since the synthesis is not achieved due to a low heating temperature, and when higher than 800° C., there is a possibility in that the solid electrolyte is synthesized in a different phase rather than a tetragonal phase, so that it is preferable to maintain the range of 700° C. to 800° C.

When the heating time is less than 12 hours, smooth synthesis of a reactant is degraded due to insufficient heating time, and when greater than 48 hours, a chemical reaction may occur between the reactant and a quartz tube, thereby producing a synthesized product different from the solid electrolyte, so that it is preferable to maintain the heating time in the range of 12 hours to 48 hours.

In the method for preparing the solid electrolyte composition, a process of pelletizing the solid electrolyte composition prepared through the step (c) by pressing the solid electrolyte composition at −20° C. to 200° C., and 300 MPa to 400 MPa, for 1 minute to 10 minutes may be further included.

### Example 1

Raw materials used for synthesis in all embodiments had a purity of 99% or greater and were used as purchased without any further purification.

Each raw material was prepared in the following composition ratio in about 1 g of a reactant.
Na₂S (Alfa-aesar) 33.24 wt %,
Zn (Sigma-aldrich) 15.92 wt %,
Ga₂S₃ (Alfa-aesar) 43.03 wt %, and
S (Sigma-aldrich) 7.81 wt %

First, a stainless steel ball (10 mm) and about 1 g of the reactant were placed together in a stainless steel pot for a ball mill grinder (PULVERISETTE 23, FRISTCH) to be ground for 5 minutes at a frequency of 40 Hz, and then the ground powder was put into a quartz tube.

The entire process was performed in a glove box filled with argon. Each quartz tube was closed with a quartz stopper, taken out of the glove box, and immediately connected to a vacuum sealer (NBD-DXZ-02, Nobody Sci. Tech. Co.). Thereafter, the sealed tube was placed in a box furnace, heated (5° C./min) to a temperature of 750° C., and maintained for 12 hours, and then the quartz tube was taken out and slowly cooled (−5° C./h) to 400° C. and then naturally cooled to room temperature to synthesize a solid electrolyte composition.

Through the above, a material having the composition of Na_{2.8}Zn_{0.8}Ga_{1.2}S₄ was obtained.

### Example 2

Each raw material was prepared in the following composition ratio in about 1 g of a reactant.
Na₂S (Alfa-aesar) 33.75 wt %,
Zn (Sigma-aldrich) 16.86 wt %,
Ga₂S₃ (Alfa-aesar) 41.12 wt %, and
S (Sigma-aldrich) 8.27 wt %

A material having the composition of Na_{2.85}Zn_{0.85}Ga_{1.15}S₄ was obtained through the same process as in Example 1 by using the above raw materials.

### Example 3

Each raw material was prepared in the following composition ratio in about 1 g of a reactant.
Na₂S (Alfa-aesar) 34.24 wt %,
Zn (Sigma-aldrich) 17.81 wt %,
Ga₂S₃ (Alfa-aesar) 39.22 wt %, and
S (Sigma-aldrich) 8.73 wt %

A material having the composition of Na_{2.9}Zn_{0.9}Ga_{1.1}S₄ was obtained through the same process as in Example 1 by using the above raw materials.

### Example 4

Each raw material was prepared in the following composition ratio in about 1 g of a reactant.
Na₂S (Alfa-aesar) 32.24 wt %,
Zn (Sigma-aldrich) 14.01 wt %,
Ga₂S₃ (Alfa-aesar) 46.88 wt %, and
S (Sigma-aldrich) 6.87 wt %

A material having the composition of Na_{2.7}Zn_{0.7}Ga_{1.3}S₄ was obtained through the same process as in Example 1 by using the above raw materials.

### Comparative Example 1

Each raw material was prepared in the following composition ratio in about 1 g of a reactant.
Na₂S (Alfa-aesar) 35.23 wt %,
Zn (Sigma-aldrich) 19.67 wt %,
Ga₂S₃ (Alfa-aesar) 35.44 wt %, and
S (Sigma-aldrich) 9.66 wt %

A material having the composition of Na₃ZnGaS₄ was obtained through the same process as in Example 1 by using the above raw materials.

### Comparative Example 2

Each raw material was prepared in the following composition ratio in about 1 g of a reactant.
Na₂S (Alfa-aesar) 34.74 wt %,
Zn (Sigma-aldrich) 18.74 wt %,
Ga₂S₃ (Alfa-aesar) 37.33 wt %, and
S (Sigma-aldrich) 9.19 wt %

A material having the composition of Na_{2.95}Zn_{0.95}Ga_{1.05}S₄ was obtained through the same process as in Example 1 by using the above raw materials.

### Comparative Example 3

Each raw material was prepared in the following composition ratio in about 1 g of a reactant.
Na₂S (Alfa-aesar) 31.23 wt %,
Zn (Sigma-aldrich) 12.07 wt %,
Ga₂S₃ (Alfa-aesar) 50.77 wt %, and
S (Sigma-aldrich) 5.93 wt %

A material having the composition of Na_{2.6}Zn_{0.6}Ga_{1.4}S₄ was obtained through the same process as in Example 1 by using the above raw materials.

### Comparative Example 4

Each raw material was prepared in the following composition ratio in about 1 g of a reactant.
Na₂S (Alfa-aesar) 30.20 wt %,
Zn (Sigma-aldrich) 10.12 wt %,
Ga₂S₃ (Alfa-aesar) 54.71 wt %, and
S (Sigma-aldrich) 4.97 wt %

A material having the composition of Na_{2.5}Zn_{0.5}Ga_{1.5}S₄ was obtained through the same process as in Example 1 by using the above raw materials.

### XRD Analysis

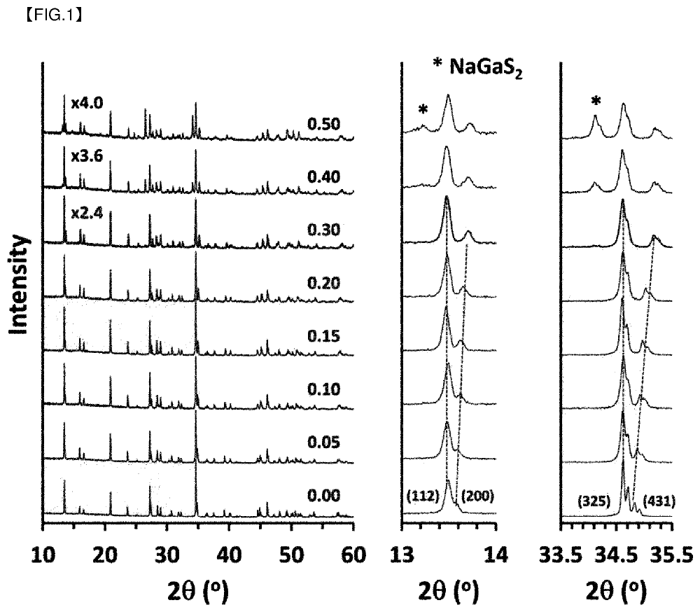

XRD analysis was performed on the solid electrolyte compositions synthesized by Examples 1 to 4 and Comparative Examples 1 to 4. The XRD peaks in FIG. 1 were obtained using a Rigaku ULTIMA4 diffractometer having a Cu Ka radiation source at a scan rate of 2.5°/min

From the results of comparing the crystal structures through X-ray diffraction, it has been confirmed that crystals with a space group I4₁/acd were synthesized in a tetragonal phase up to x values of 0 (Comparative Example 1), 0.5 (Comparative Example 2), 1.0 (Example 3), 1.5 (Example 2), 2.0 (Example 1), and 3.0 (Example 4) in Na₃₋ₓZn₁₋ₓGa₁₊ₓS₄. Among these, Example 4 had a relatively weak peak intensity, thereby exhibiting a relatively low level of crystallinity, which appears to be due to the inclusion of some amorphous phases.

Meanwhile, when the x value was 0.40 (Comparative Example 3) and 0.50 (Comparative Example 4), an impurity peak corresponding to the NaGaS₂ phase began to appear, and the decrease in peak intensity was greater compared to Example 4. From the above, it can be seen that a pure phase of Na₃₋ₓZn₁₋ₓGa₁₊ₓS₄ can only be obtained when the x value is from 0 to 0.30, and when the x value is 0.30, some amorphous phases may be contained. When the x value was 0.40 and 0.50, it was confirmed that synthesis was achieved in a form containing an impurity phase and an amorphous phase.

### EIS Analysis

In order to analyze the electrochemical properties of the Na₃₋ₓZn₁₋ₓGa_{1+X}S₄ composition synthesized according to Examples 1 to 4 and Comparative Examples 1 to 4, a cell was manufactured as follows.

First, 200 mg of the composition was ground in a hand grinding manner, and then disposed between stainless steel disks. The powder was pelletized under a pressure of 300 MPa in a polyoxymethylene (POM) mold. The thickness of the prepared pellet was about 500 μm and the area thereof was about 1.33 cm².

In addition, by using a polyether ether ketone (PEEK) mold and a hot press (200° C., 10 min, YLJ-HP60-LD, MTI Corp.), hot-pressed pellets were also prepared.

The EIS spectrum was recorded by applying a sine wave of ±10.0 mV within the frequency range of 2 MHz to 0.1 Hz (SP2, One A-Tech). An automatic WBCS 3000 battery cycler (One A-Tech) was used for voltage and constant current studies.

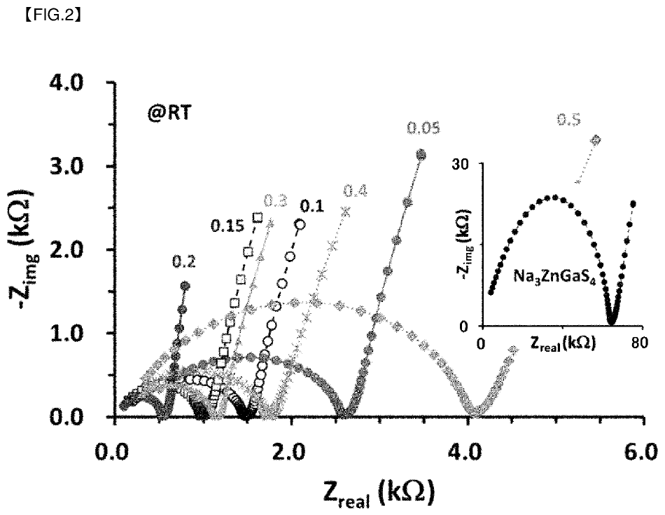

FIG. 2 is an EIS spectrum of Na₃₋ₓZn₁₋ₓGa_{1+X}S₄ (x=0 to 0.50) under the AC voltage modulation of ±10 mV at room temperature, and 2 MHz to 0.1 Hz (the illustration is an EIS spectrum of Na₃ZnGaS₄).

As confirmed in FIG. 2, the resistance of Na₃ZnGaS₄ (Comparative Example 1) was 64.7 kΩ, whereas the resistance of Na_{2.95}Zn_{0.95}Ga_{1.05}S₄ (Comparative Example 2) dropped to 2.61 kΩ, and continuously dropped to 1.49 kΩ, 0.99 k Q, and 0.55 kΩ, respectively, when the X value was 0.10 (Example 3), 0.15 (Example 2), and 0.20 (Example 1).

However, the resistance began to increase when the x value was greater than 0.30, and gradually increased to 1.12 kΩ when the x value was 0.30 (Example 4), 1.75 kΩ when the x value was 0.40 (Comparative Example 3), and 4.06 kΩ when the x value was 0.50 (Comparative Example 4). The increase in resistance that occurs when the x value is greater than 0.30, despite the increase in vacancy, appears to be due to the generation of an amorphous phase and/or the generation of an impurity phase.

Nevertheless, it can be seen from the results of Example 1 to Example 4 that the introduction of vacancies through proper adjustment of the Zn/Ga ratio greatly contributes to the improvement of ion conductivity (Sᵢₒₙ) If not controlled in such a manner, the ion conductivity (Sᵢₒₙ) becomes too low to be used as a solid electrolyte.

In addition, in the synthesized composition, temperature dependence of the ion conductivity (Sᵢₒₙ) between −20° C. to +60° C. was investigated.

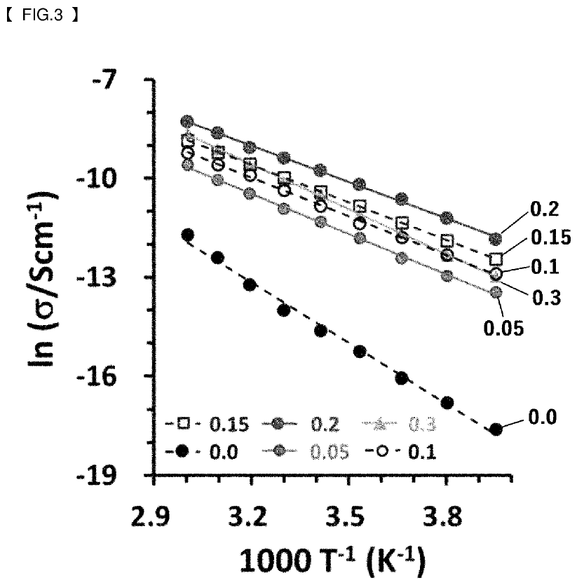

FIG. 3 is an Arrhenius plot of ion conductivity (Sion) in Na₃₋ₓZn₁₋ₓGa₁₊ₓS₄ (x=0˜0.30) between −20° C. to +60° C.

As confirmed in FIG. 3, all Na₃₋ₓZn₁₋ₓGa_{1+X}S₄ (x: 0 to 0.50) compounds showed a linear behavior satisfying the Arrhenius relationship (Sᵢₒₙ=S₀ₑₓₚ(−E_{A}/RT), E_{A}: activation energy; R: gas constant; T: absolute temperature). This means that the change in slope according to the x value in Na₃₋ₓZn₁₋ₓGa₁₊ₓS₄ exactly matches the change in ion conductivity (Sᵢₒₙ) at room temperature.

In Na₃ZnGaS₄, which is Comparative Example 1, the steepest slope gradually became gentler with the introduction of vacancies until the x value was 0.20, but the slope slightly increased again from the x value of 0.30. That is, the solid electrolyte compositions according to Examples 1 to 4 exhibit relatively good temperature dependence properties compared to that of Comparative Example 1.

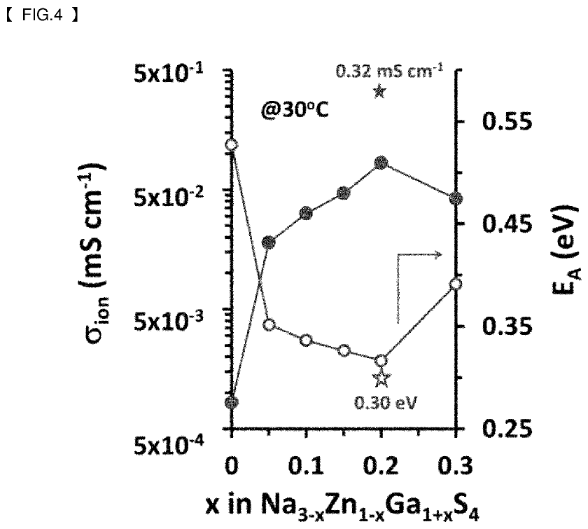

FIG. 4 shows the change in ion conductivity (Sᵢₒₙ) and activation energy (E_{A}) according to x at 30° C.

As confirmed in FIG. 4, there is an inverse behavior between the ion conductivity (Sᵢₒₙ) and the activation energy (E_{A}), which means that the generation of vacancy sites promotes Na⁺ conduction by reducing the activation barrier.

The Na_{2.8}Zn_{0.8}Ga_{1.2}S₄ composition, which is Example 1, has the highest ion conductivity of 0.08 mScm⁻¹, and the lowest activation energy (E_{A}) value of 0.32 eV, so that it can be seen that the composition is the most preferable example of a solid electrolyte composition.

Meanwhile, in the case of the hot-pressed Na_{2.8}Zn_{0.8}Ga_{1.2}S₄ pellet (marked with an asterisk in FIG. 4), the ion conductivity (Sᵢₒₙ) reached 0.32 mScm⁻¹, and at this time, the activation energy E_{A} was reduced to 0.30 eV.

### Evaluation of Moisture Stability

The stability of Na_{2.8}Zn_{0.8}Ga_{1.2}S₄, which is the composition according to Example 1, against moisture or water was evaluated. For comparison with the composition of Example 1, typical sulfide-based solid electrolyte compositions, Na₃PS₄ and Na₃SbS₄, were evaluated together.

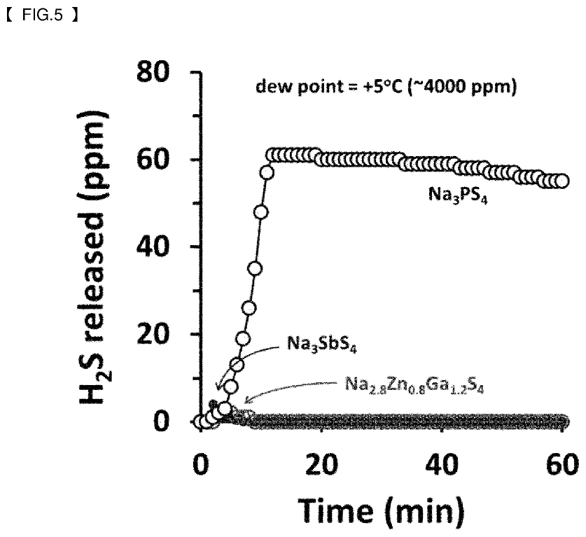

FIG. 5 shows the results of measuring the change in concentration of H₂S gas released from Na_{2.8}Zn_{0.8}Ga_{1.2}S₄, Na₃PS₄, and Na₃SbS₄ compositions while being exposed to humid N₂ (dew point±5° C., approximately 4,000 ppm).

Referring to FIG. 5, Na₃PS₄ showed a rapid increase in H₂S concentration when exposed to wet N₂, and a high level of H₂S (about 60 ppm) was maintained during the measurement. Na₃PS₄ exhibited the property of being very vulnerable to moisture.

In contrast, Na_{2.8}Zn_{0.8}Ga_{1.2}S₄ and Na₃SbS₄, each of which is Example 1, exhibited an inert state except for some initial reactions, so that it can be seen that the stability thereof against N₂ is good.

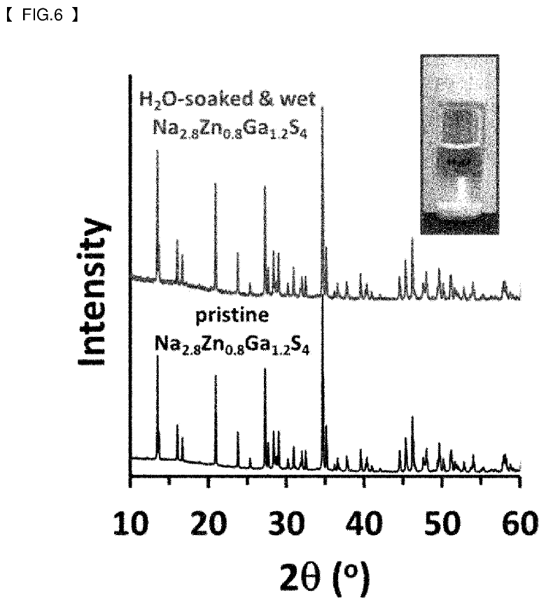

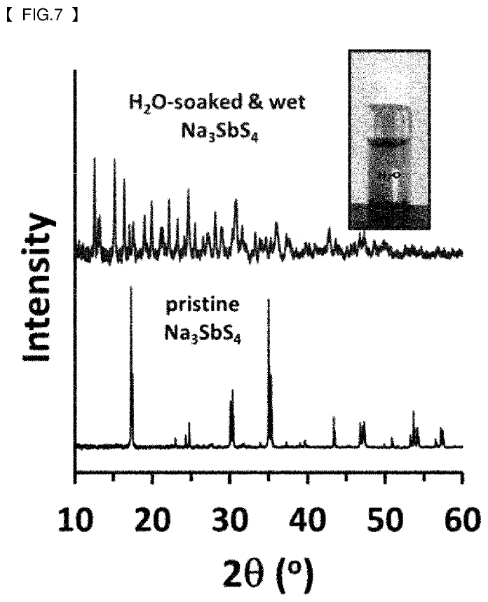

FIG. 6 is an XRD pattern of Na_{2.8}Zn_{0.8}Ga_{1.2}S₄ in the initial state and Na_{2.8}Zn_{0.8}Ga_{1.2}S₄ in a state immersed in water (internal image of FIG. 6), and FIG. 7 is an XRD pattern of Na₃SbS₄ in the initial state and Na₃SbS₄ in a state immersed in water (internal image of FIG. 7).

As confirmed in FIG. 6, no visual change was observed in Na_{2.8}Zn_{0.8}Ga_{1.2}S₄, which is Example 1, in a state dispersed in water, and the XRD pattern of wet powder was the same as the XRD pattern of initial powder, which indicates complete inertness even when immersed in water.

In addition, no degradation in ion conductivity (Sᵢₒₙ) was observed in the EIS spectrum measured after drying the immersed powder at 80° C.

In contrast, as confirmed in the internal image of FIG. 7, when Na₃SbS₄ is dispersed in water, the temperature of the water slightly increases, and the color of the water is changed to yellow. In addition, the XRD pattern was also greatly changed and did not match the pattern of Na₃SbS₄·9H₂O.

From the above, it can be seen that the Na_{2.8}Zn_{0.8}Ga_{1.2}S₄ composition according to Example 1 has properties of being substantially inert to water, and the properties means that it is possible to synthesize and/or process the composition according to Example 1 in an aqueous medium without having to perform dehydration treatment.

### Evaluation of Battery Properties

The possibility of using the Na_{2.8}Zn_{0.8}Ga_{1.2}S₄ composition according to Example 1 as a solid electrolyte was evaluated.

To this end, a symmetric Na₂Sn|Na_{2.8}Zn_{0.8}Ga_{1.2}S₄|Na₂Sn cell was manufactured.

The symmetric cell is manufactured by placing 30 mg of an Na2Sn alloy, which is prepared by performing mechanic synthesis using a ball mill grinder (PULVERISETTE 23, FRISTCH), into a polyoxymethylene (POM) mold of a cell, and then flattening the same. Thereafter, 200 mg of the solid electrolyte is added thereto and flattened again, and then 30 mg of Na₂Sn is further added thereon to manufacture the cell.

In addition, a Na₂Sn|Na_{2.8}Zn_{0.8}Ga_{1.2}S₄|TiS₂ cell was manufactured, wherein a positive electrode was manufactured by dissolving 50% of Na_{2.8}Zn_{0.8}Ga_{1.2}S₄, 45% of TiS₂, and 5% of CF in N-methyl-2-pyrrolidone, followed by vacuum drying the mixture at 150° C. Thereafter, 5 mg of the positive electrode material was placed into the polyoxymethylene (POM) mold of the cell, and 150 mg of the solid electrolyte was added thereto and then flattened, and then 30 mg of Na₂Sn, which is a negative electrode material, was added and pressed under a pressure of 300 MPa.

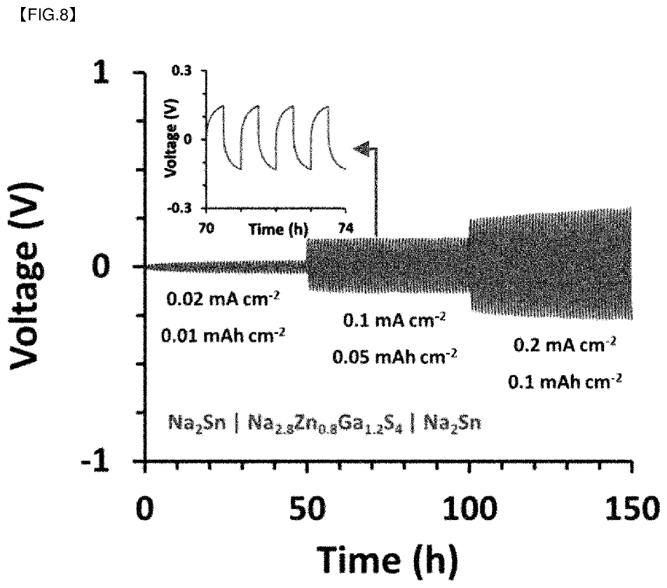

FIG. 8 shows the change in voltage during Na alloying/dealloying in the symmetric Na₂Sn|Na_{2.8}Zn_{0.8}Ga_{1.2}S₄Na₂Sn cell.

The composition according to Example 1 showed good compatibility with the Na₂Sn alloy (about 0.3 V vs. Na/Na⁺) As confirmed in FIG. 8, the symmetric cell of the Na₂Sn Na_{2.8}Zn_{0.8}Ga_{1.2}S₄Na₂Sn composition showed a stepwise increase in overvoltage (hs) as the current density increased during the constant current alloying/dealloying cycle. This means that interfacial stability has already been established during the initial tens of cycles at 0.02 mAcm⁻².

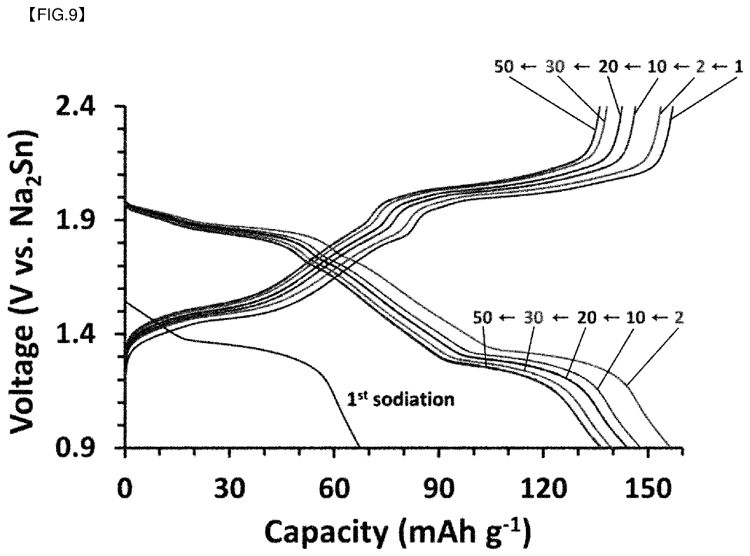

FIG. 9 is a voltage curve of Na₂Sn|Na_{2.8}Zn_{0.8}Ga_{1.2}S₄ TiS₂ during a constant current cycle at 0.03 mAcm⁻².

The voltage profile showed a slightly inclined behavior, which is commonly observed in all-solid-state cells of TiS₂. The cell had an initial sodiation capacity of only 67 mAh/g, but the capacity was rapidly increased to 157 mAh/g during a subsequent desodiation process. Such a behavior appears to be due to a chemical reaction between Na_{2.8}Zn_{0.8}Ga_{1.2}S₄ and TiS₂ during a physical contact such that each of the solid electrolyte and TiS₂ is partially oxidized and reduced. Once oxidized, a decomposition product of Na_{2.8}Zn_{0.8}Ga_{1.2}S₄ appears to stabilize the interface without continuous decomposition. In fact, the capacity slowly decreased from 157 mAh/g to 136 mAh/g over the next 50 cycles (capacity retention rate was 87%), and the Coulomb efficiency was higher than 99.5%.

From the above results, it can be seen that the Na_{2.8}Zn_{0.8}Ga_{1.2}S₄ composition may be used as a solid electrolyte of an all-solid-state battery.

The foregoing description of the invention has been presented for purposes of illustration, and it will be understood by those skilled in the art that various changes in form and details may be made therein without departing from the spirit and scope of the invention. Therefore, it should be understood that the embodiments described above are illustrative in all aspects and are not limiting. For example, each component described in a singular form may be distributed and implemented, and similarly, components described as being distributed may also be implemented in a combined form.

The scope of the invention is represented by the following claims rather than the above detailed description, and all changes and changed forms derived from the meaning and scope of the claims and their equivalent concepts should be construed as being included in the scope of the invention.

What is claimed is:

1. A solid electrolyte composition comprising a material represented by [Formula 1] below:
NaₐZn_{b}Ga_{c}S_{d} Formula 1
(wherein, 2.70≤a≤2.90, 0.70≤b≤0.90, and 1.10≤c≤1.30)

2. The solid electrolyte composition according to claim 1, wherein the space group of the material represented by [Formula 1] above is I4₁/acd.

3. The solid electrolyte composition according to claim 1, wherein the ion conductivity σᵢₒₙ at room temperature (25° C.) of the material represented by [Formula 1] is at least 0.1 mScm⁻¹.

4. The solid electrolyte composition according to claim 1, wherein the material represented by [Formula 1] above is inert to water.

5. The solid electrolyte composition according to claim 1, wherein in the material represented by [Formula 1] above, a is 2.75 to 2.85, b is 0.75 to 0.85, and c is 1.15 to 1.25.

6. The solid electrolyte composition according to claim 1, wherein the material represented by [Formula 1] above is a tetragonal phase.

7. A method for producing a solid electrolyte composition including a material represented by [Formula 1] below, the method comprising:
(a) mixing raw materials;
(b) heating the mixed materials to a predetermined temperature and maintaining the same for a predetermined period of time; and
(c) cooling the heated materials:
NaₐZn_{b}Ga_{c}S_{d} Formula 1
(wherein, 2.70≤a≤2.90, 0.70≤b≤0.90, and 1.10≤c≤1.30)

8. The method according to claim 7, wherein the step (b) above is performed at 700° C. to 800° C. for 12 hours to 48 hours.
